(19) United States
(12) Patent Application Publication
(10) Pub. No.: US 2006/0207117 A1
(43) Pub. Date: Sep. 21, 2006

(54) Posture monitoring and correcting device, system and method

(76) Inventor: Wendy Sobol, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/318,272

(22) Filed: Dec. 23, 2005

Related U.S. Application Data
(60) Provisional application No. 60/639,862, filed on Dec. 27, 2004.
(60) Provisional application No. 60/738,490, filed on Nov. 21, 2005.

(51) Int. Cl. G01C 15/00

(52) U.S. Cl. 33/286

(57) ABSTRACT

A posture-checking device includes a reference-datum locating member including a reflective surface and at least one datum indicia which is movable with respect to a display device to setup the reference-datum locating member to provide an indication of proper posture for a specific user. The reference-datum locating member reflects a reference-datum fixedly associated with the user, for example, eyes, nose, mouth, in relation to the datum indicia. After initial setup, the visually checks the relationship of the reference-datum with respect to the datum indicia while interacting with the display device, and adjusts his or her posture as indicated by any discrepancy. A system may employ one or more reference-datum locating members for adjusting.

### BACKGROUND OF THE INVENTION

1. Field of the Invention

This disclosure generally relates to devices, systems and methods for checking and maintaining proper posture, and more particularly to a device, a system and a method for maintaining proper posture while interacting with a display device.

2. Description of the Related Art

Individuals increasingly interact with various display devices for work, personal use or both. Such display devices may, for example, take the form of computer displays or monitors, television screens, radar screens, security monitors or other display devices.

Proper placement of the display device with respect to the user reduces the likelihood of the user developing skeletomuscular problems. However, even when properly setup, poor posture may lead to the user developing skeletomuscular problems.

Proper posture typically entails holding the head upright while maintaining a natural curve of the spine such that the moment exerted on the spine by the body is at a minimum. However, modern occupations typically entail sitting at a display device for long periods of time. During such interactions, users typically become fatigued and may adopt poor or incorrect posture, for example tilting their head downward and leaning forward in a chair. The user is often highly focused on a task, and consequently is not aware of their change in posture.

Accordingly, in recent years there has been a noticeable rise in skeletomuscular injuries among those who frequently interact with display devices, such as computer users. Such injuries are especially hazardous to long-term health because they gradually occur over time, without noticeable decline signals during a daily routine to warn users of the potential for skeletomuscular injuries. Additionally, once such injuries occur, their treatment often involves a prolonged process of physical therapy or medication or both, and in severe cases, surgical procedures. Furthermore, poor posture results in gradual deformation of the spine, which in turn exhibits an unpleasant appearance often associated with, but not limited to, an arched back.

Devices have been introduced, such as keyboard trays and ergonomic chairs, to aid in correcting poor posture while the user interacts with a keyboard or other input device. However, these devices are only beneficial if the user remembers to use them properly, and such devices typically lack means for periodically reminding the user to maintain the desired position for a prolonged period. Furthermore, these devices are unrelated to affecting the posture with respect to the display device, which is often a crucial aspect of maintaining proper posture. Accordingly, methods have been introduced to manipulate seating positions with respect to the display device to attain proper posture. However, it is common for multiple users with distinct skeletomuscular attributes to use a common workstation or display device. For such users it is not practicable to frequently reposition the display device to provide a proper reference point that suits each user's unique skeletomuscular attributes. Additionally, such methods are lack means to remind users to align their body with the display device.

A device, system and/or method of allowing or encouraging a user to maintain proper posture while interacting with a display device is desirable, particularly one that is inexpensive, easy and convenient to use, and that accommodates users of different skeletomuscular attributes, and that is capable of periodically reminding the user of the proper posture to be maintained.

### BRIEF SUMMARY OF THE INVENTION

In one embodiment, a posture-checking device for use by a user of a display device in maintaining posture over time, includes reflecting means for reflecting a reference-datum fixedly associated with the user of the display device, the reflecting means mounted for movement with respect to the display device to setup the posture-checking device for the user, and at least one datum indicia positioned to provide a reference datum extending at least partially across a portion of the reflecting means to provide an indicia of proper posture when the reflected reference-datum is aligned with respect to the at least one datum indicia.

In one embodiment, a posture-checking system for a display device includes at least a first reference-datum locating device having a reflective surface and at least a first datum indicia, and first mounting means for movably mounting the first reference-datum locating device for movement with respect to the display device to selectively align at least the first datum indicia with a reference-datum fixedly associated with a user to provide a first visual indication of when the user is correctly postured.

In one embodiment, a method for maintaining a proper posture while interacting with a display device includes positioning a reference-datum locating device proximate to the display device, assuming a proper posture and aligning a datum indicia of a reflective surface of the reference-datum locating device with a reference-datum fixedly associated with a user and reflected on the reflective surface, periodically inspecting the reflective surface for alignment of the datum indicia with the reference-datum, and resuming the proper posture when misalignment of the datum indicia with the reference-datum is detected by realigning the datum indicia with the reference-datum.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1 is an isometric view of a user interacting with a display device and a posture-checking device where the user is maintaining a proper posture.

FIG. 2 is an isometric view of a posture-checking device according to an illustrated embodiment comprising a reference-datum locating member.

FIG. 3 is a rear view of the reference-datum locating member of FIG. 2.

FIG. 4 is an isometric view of a user interacting with a display device and a posture-checking device where the user has moved into an improper posture.

FIG. 5A is an isometric view of a posture-checking device according to another illustrated embodiment.

FIG. 5B is a top plan view of the posture-checking device of FIG. 5A.

FIG. 6 is a front view of a posture-checking device according to yet another illustrated embodiment including a reflective surface.

FIG. 7 is a front view of a reflective surface of a posture-checking device according to still another illustrated embodiment.

FIG. 8 is a front view of a posture-checking device according to another illustrated embodiment.

FIG. 9 is a front view of a posture-correcting system according to an illustrated embodiment.

FIG. 10 is a front view of a posture-correcting system according to another illustrated embodiment.

FIG. 11 is a front view of a posture-correcting system according to yet another illustrated embodiment.

FIG. 12 is a front view of a posture-correcting system according to still another illustrated embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with display devices, adhesives, attachment devices, identification devices and illumination devices including but not limited to computer monitors, pressure sensitive adhesives, hook and loop fasteners, retinal identification devices and laser diodes, respectively, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” or “an illustrated embodiment” means that a particular feature, structure or characteristic described in connection with the embodiment is included in at least one embodiment. Thus, the appearances of the phrases “in one embodiment” or “in an embodiment” or “in an illustrated embodiment” in various places throughout this specification are not necessarily all referring to the same embodiment. Furthermore, the particular features, structures, or characteristics may be combined in any suitable manner in one or more embodiments.

Reference throughout this specification to “display device”, “screen”, or “computer monitor” is not intended in a limiting sense, but is rather intended to refer to any device with which a user interacts for a short or prolonged duration such as, but not limited to, computer monitors, television screens, security monitors, identification devices, radar screens, image-capturing devices such as, but not limited to, cameras or any other device across from which a user may be positioned for a particular purpose.

Reference throughout this specification to “reference-datum” is not intended in a limiting sense, but is rather intended to refer to any point, line, object or body part or any combination thereof that can be used as a reference indicia to selectively align a body of a user with whom the reference indicia is fixedly associated.

Reference throughout this specification to “datum indicia” is not intended in a limiting sense, but is rather intended to refer to any point, line, object or any combination thereof that can be used as a reference indicia with which a user can align a reference-datum.

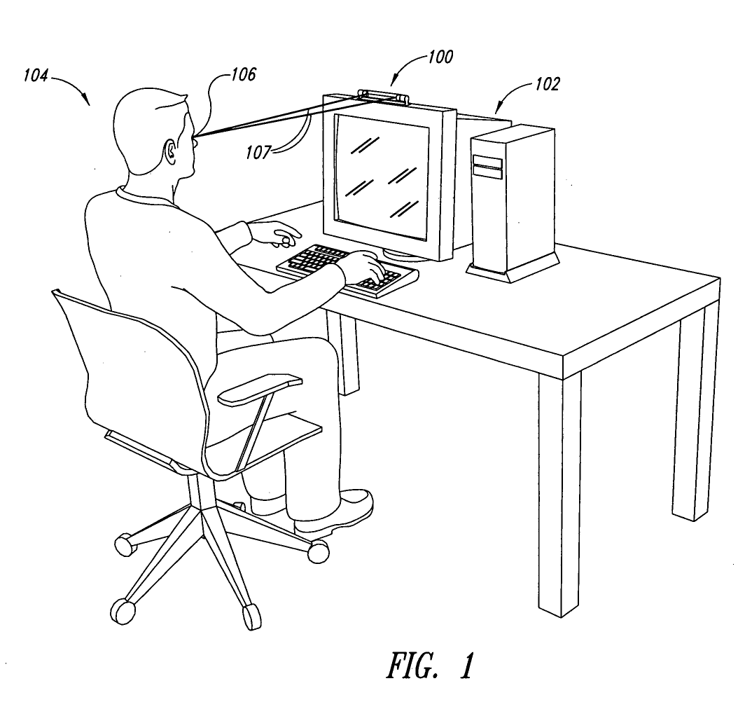

FIG. 1 shows a posture-checking device 100 positioned on a display device 102 with which a user 104 interacts, according to one illustrated embodiment. The user 104 may from time-to-time, visually check the position of a reference-datum 106 reflected 107 by the posture-checking device 100 to ensure that the user 104 has maintained a proper posture with respect to the display device 102 over a period of use.

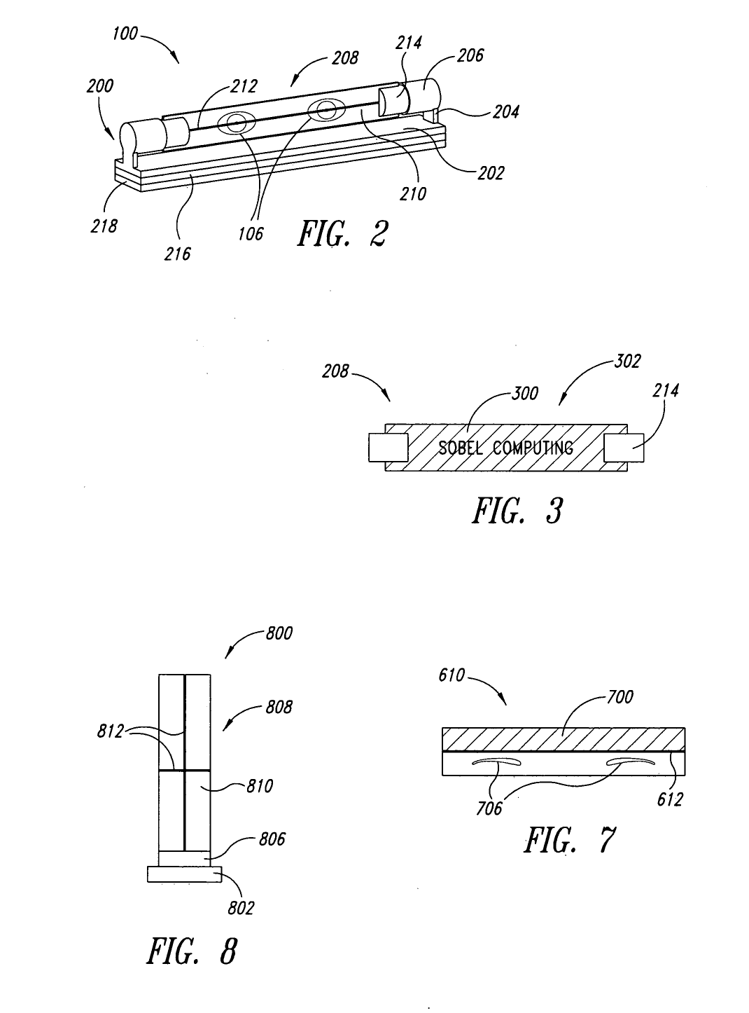

FIG. 2 shows the posture-checking device 100 according to one illustrated embodiment. The posture-checking device 100 may include a frame 200 comprising a base 202, two support members 204, and two receptacle members 206. The support members 204 couple the receptacle members 206 to the base 202. The posture-checking device 100 may further include a reference-datum locating member 208 comprising a reflective surface 210, at least one datum indicia 212 that is at least partially contiguous to the reflective surface 210, and two coupling members 214 pivotally or rotatably coupling the reference-datum locating member 208 to the receptacle members 206 of the frame 200.

The reflective surface 210 can be a mirror, a chrome coating, a metallic layer, or any other coating, layer, surface, or plane having reflective qualities. The datum indicia 212 can be a point, a line, an illumination beam, two points, a groove or a notch extending at least partially across the reflective surface 210 or any other indicia with which a reference-datum can be aligned upon reflecting from the reflective surface 210. The datum indicia 212 may be inscribed on, etched in, or otherwise formed on, in or under the reflective surface 210.

The coupling members 214 can be pivotally or rotatably coupled to the receptacle members 206 using a bearing device, or the receptacle members 206 may have a cylindrical protrusion captively received in the coupling members 214 and around which the coupling members 214 can slidably pivot or rotate, or the coupling members 214 can be slidably and pivotally or rotatably received in the receptacle members 206. Additionally, or alternatively, an elongated cylindrical member such as, but not limited to, a pin, can pivotally or rotatably extend through the receptacle members 206 and the coupling members 214, pivotally or rotatably coupling the receptacle members 206 to the coupling members 214.

FIG. 3 shows that the reference-datum locating member 208 may also include an opaque substrate 300 on a surface, at least partially opposing the reflective surface 210 (FIG. 2) to improve the clarity of reflection from the reflective surface 210. FIG. 3 also shows a message, for example an advertising message 302, that may be carried on the opaque substrate 300. The message 302 may be viewed by the user 104 when the reference-datum is positioned to display such to the user 104. The advertising message 302 may be visible to the user 104 only when the datum indicia 212 is not visible, for example by placing the advertising message 302 on a side diametrically opposed to the reflective surface 210. Such would advantageously avoid interfering with use of the datum indicia 212. Alternatively, the advertising message 302 may be visible to the user 104 when the datum indicia 212 is visible, for example by placing the advertising message 302 on a side that is not diametrically opposed to the reflective surface 210, for example where the reference-datum locating member 208 has three or more surfaces or sides. Additionally, or alternatively, the advertising message 302 may be located on, in or under the reflective surface 210 and hence visible when the datum indicia 212 is visible. In some embodiments, the advertising message 302 may serve as the datum indicia 212, for example, forming a line extending at least partially across a width of the reflective surface 210.

Referring to FIGS. 1 and 2, the user 104 of FIG. 1 or some other individual can position the posture-checking device 100 on a display device 102 and upon assuming a proper posture, the user 104 may selectively pivot or rotate the reference-datum locating member 208 to receive a reflection 107 of a reference-datum 106 and align the reflection of the reference-datum 106 in the reflective surface 210 with the datum indicia 212, shown in FIG. 2. As noted above, the reference-datum 106 can be a point, a line, an object, a body part (e.g., eyes, eyebrows, nose, mouth, chin, forehead, hairline, eyeglass frame), or any other reference that is fixedly associated with the user 104 such that a change in posture of the user 104 results in a substantially similar displacement of the reference-datum 106. Once the posture-checking device 100 has been calibrated to reflect the reference-datum 106 in selective relation to the datum indicia 212, the user can, from time-to-time, inspect the reflective surface 210 of the reference-datum locating member 208 to detect misalignment of the datum indicia 212 with the reference-datum 106.

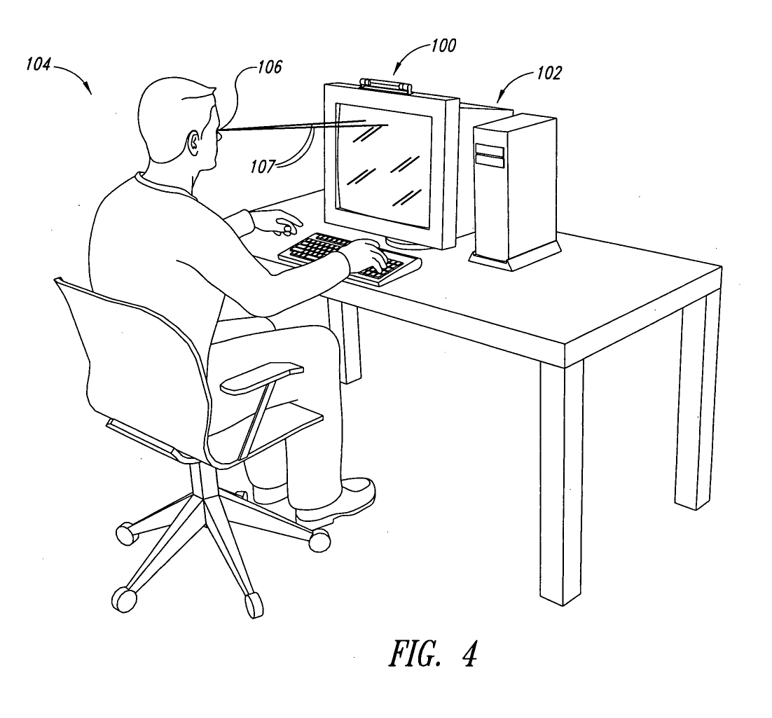

As shown in FIG. 4, after the posture-checking device 100 is calibrated to the proper posture of the user 104, the reflection 107 of the reference-datum 106 misaligns with the datum indicia 212 when the user 104 assumes a poor posture. Upon detecting a misalignment, the user 104 may adjust their posture so as to realign the datum indicia 212 with the reference-datum 106 to resume the proper posture, as shown in FIG. 1.

In the exemplary embodiments of FIG. 1 and FIG. 4, the reference-datum 106 is illustrated as the eyes of the user 104, which are reflected in the reflective surface 210 of the reference-datum locating member 208 (best illustrated in FIG. 2). Therefore, the user 104 can align his or her eyes such that when the user 104 is assuming the proper posture, the eyes of the user 104 are reflected in the reflective surface 210, the eyes being symmetrical about the datum indicia 212, as shown in FIG. 2.

As shown in FIG. 4, upon assuming a poor posture, the user detects a reflection of the reference-datum 106 (e.g., the eyes of the user 104) misaligned with respect to the datum indicia 212, when the user inspects the reflective surface 210 of the reference-datum locating member 208. Therefore, the user 104 is reminded to resume proper posture. Since the posture-checking device 100 is located within the same line of sight of the user 104 as that when the user 104 is interacting with a display device 102, the user 104 is constantly reminded to inspect the reflective surface 210 to ensure proper posture is maintained.

Furthermore, FIG. 2 illustrates an optional adhesive member 216 for securing the posture-checking device 100 to the display device 102, shown in FIG. 1. The adhesive member 216 may be a pressure sensitive adhesive, a permanent adhesive, a removable adhesive, or any other adhesive that provides sufficient adhesion between the posture-checking device 100 and the display device 102 to prevent unintentional displacement of the posture-checking device 100. As shown in FIG. 2, an optional release liner 218 may cover the adhesive member 216, prior to use. The release liner 218 serves to maintain the adhesion qualities of the adhesive member 216 and can be removed at the time of securing the posture-checking device 100 to the display device 102.

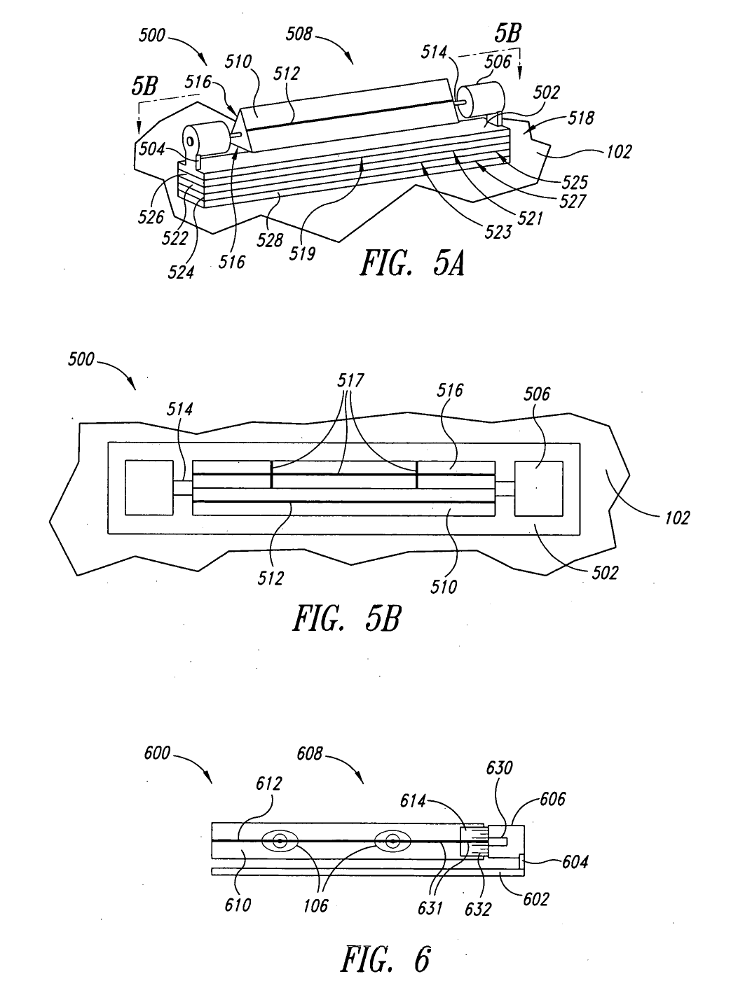

In another embodiment shown in FIG. 5A, a posture-checking device 500 includes a base 502 and at least two support members 504 attaching the base 502 to at least two coupling members 506. The posture-checking device 500 also includes a reference-datum locating member 508 comprising at least a first reflective surface 510 and at least a first datum indicia 512, the first datum indicia 512 at least partially positioned with the first reflective surface 510. The reference-datum locating member 508 is coupled to the coupling member 506 via an elongated cylindrical member 514 such as, but not limited to, a pin rotatably extending through the reference-datum locating member 508 and received in the coupling member 506. Furthermore, the reference-datum locating member 508 can include a plurality of surfaces 516 in addition to the reflective surface 510, for example two additional surfaces.

The additional surfaces 516 can serve numerous purposes such as, but not limited to, advertisements, an LCD time or date display device, POST IT® sheets by 3M, or any other purpose that may be useful while using a display device 102 shown in FIG. 1, such as a computer monitor. Additionally, or alternatively, the extra surfaces 516 may also be reflective surfaces that include at least one datum indicia 517, different from the first datum indicia 512 of the first reflective surface 510, as shown in FIG. 5B. Such an embodiment may accommodate multiple users 104 of FIG. 1, using the same display device 102, each user 104 having a different datum indicia preference. A subsequent user 104 of the same display device 102 can rotate the reference-datum locating member 508 to use one of the reflective surfaces 510, 516 having the datum indicia 512, 517 preferred by the current user 104.

Additionally, or alternatively, the posture-checking device 500 may include other securing means 518, such as hook and loop fasteners including, but not limited to VELCRO® fasteners or DUAL LOCK™ fasteners by 3M. Such securing means 518 can include a hook layer 522 and a loop layer 524. A surface 523 of the hook layer 522 includes hooks such as nylon hooks, which are well known in the field. A surface 521 of the hook layer 522 opposing the surface 523, can be attached to a surface 519 of the base 502 that is proximate to the display device 102 when in use, using an adhesive member 526. A surface 525 of the loop layer 524 includes loops that are also well known in the field. A surface 527 of the loop layer 524 opposing the surface 525, can be selectively secured to a display device 102 using an adhesive member 528. Therefore, the posture-checking device 500 can be selectively removably secured on the display device 102 by placing the surface 523 of the hook layer 522 over the surface 525 of the loop layer 524. An optional removable release liner such as the release liner 218 shown in FIG. 2 can substantially cover the adhesive member 528 adjacent the loop layer 524 prior to use.

It will be understood that various embodiments may or may not incorporate one or more of the aforementioned components, or may incorporate additional components. For example, as shown in FIG. 6, a posture-checking device 600 may comprise only one support member 604 coupling a base 602 to only one receptacle member 606. Furthermore, the receptacle member 606 may receive only one coupling member 614 of a reference-datum locating member 608, where the coupling member 614 is fabricated from a transparent material such as glass, plastic, crystal, acrylic or any other transparent or translucent material.

Additionally, or alternatively, the posture-checking device 600 may include an illumination device 630, such as, but not limited to, a laser diode or an LED, secured in the receptacle 606 and operable to transmit an illumination beam 631 through the coupling member 614 and across the reflective surface 610, allowing a user 104 of FIG. 1 to align a reference-datum 106 with the illumination beam 631 emitted from the illumination device 630, shown in FIG. 6.

Furthermore, the coupling member 614 may include at least one position indicia 632 such as, but not limited to, dial marks. In such an embodiment, multiple users 104 of the same display device 102 of FIG. 1, need only calibrate the posture-checking device 600 once and remember or record the corresponding dial position on the position indicia 632 associated with their preferred position of the reference-datum locating member 608. A subsequent user 104 using the same display device 102 of FIG. 1 can adjust the reference-datum locating member 608 of FIG. 6 by rotating the reference-datum locating member 608 to the appropriate dial location on the position indicia 632 previously calibrated to correspond to a proper posture for that user 104.

An individual of ordinary skill in the art, having reviewed this disclosure, will appreciate these and other variations that can be made to the posture-checking device 600 without deviating from the spirit of the invention. For example, as shown in FIG. 7, the reflective surface can include an opaque portion 700 to exaggerate the datum 612. The user 104 of FIG. 1 may align a reference-datum 706 shown in FIG. 7, such as the eyebrows of the user 104, to reflect immediately below the opaque portion 700 when the user assumes a proper posture.

In still another embodiment, as illustrated in FIG. 8, a posture-checking device 800 comprises a base 802 pivotally or rotatably receiving coupling means 806 of a reference-datum locating member 808. The reference-datum locating member 808 also includes a reflective surface 810 and at least two datum indicia 812. A user may use the posture-checking device 800 in a similar fashion as that described in regard to other embodiments herein to maintain proper posture during interaction with a display device 102, shown in FIG. 1. Additionally, or alternatively, a user 104 (FIG. 1) may use more than one posture-checking device 800 to conform his or her body posture to a desired lateral position. For example, two posture-maintaining devices 800 may be positioned on opposing sides of a top surface of an image-capturing device to align the body of a user 104 of FIG. 1 to be within the peripheral range of a lens of the image-capturing device (not shown).

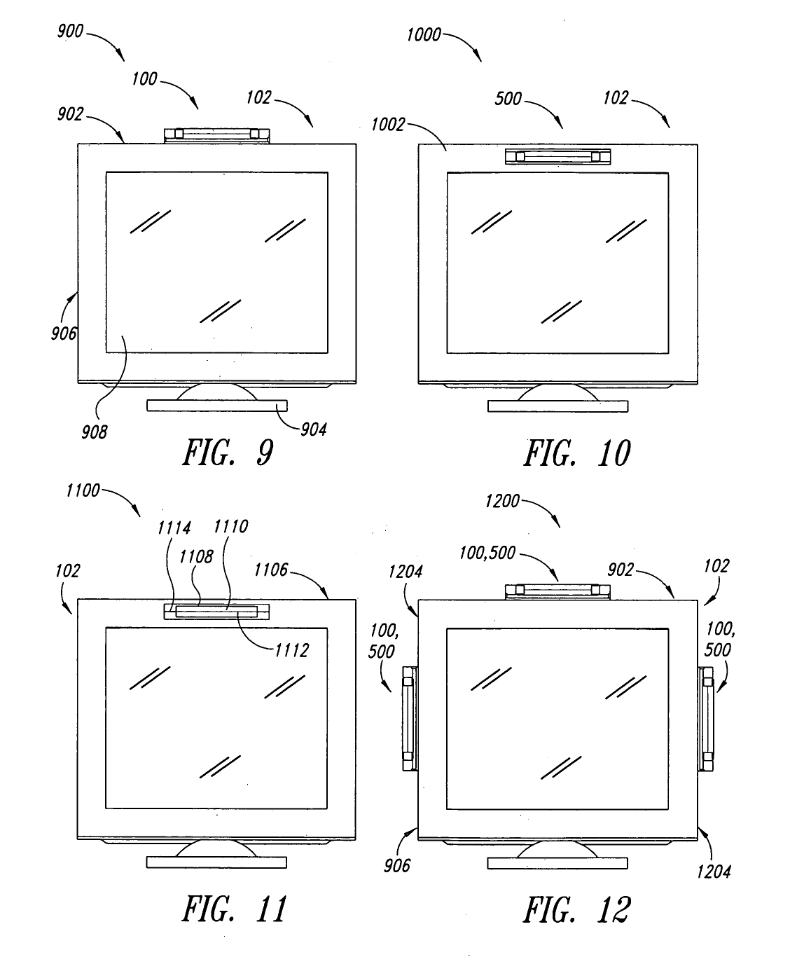

FIG. 9 shows a posture-correcting system 900 according to another embodiment which comprises the posture-checking device 100 (FIG. 2), removably mounted on a top surface 902 of a display device 102. Mounting means may include an adhesive member 216 (FIG. 2) or securing means 518 (FIG. 5A). The display device 102 also includes a base 904 and a housing 906, which houses display components including a display panel 908.

FIG. 10 shows yet another embodiment of a posture-correcting system 1000, comprising a posture-checking device 500 (FIG. 5A), removably mounted on a front surface 1002 of the display device 102. Mounting means may include an adhesive member 216 (FIG. 2) or securing means 518 (FIG. 5A).

In yet another embodiment shown in FIG. 11, a posture-correcting system 1100 comprises a display device 102 and a reference-datum locating device 1108 including a reflective surface 1110, at least one datum indicia 1112, and coupling means 1114. The coupling means 1114 pivotally or rotatably couples the reference-datum locating device 1108 to a housing 1106 of the display device 102, thereby eliminating the need for additional structure associated with a stand-alone posture-checking device as described herein. The system 1100 is well suited for, but not limited to, commercial applications in which the display device 102 may be subject to frequent relocation. In such applications, the reference-datum locating device 1108 is conveniently integrated with the housing 1106 of the display device 102, making it easier to package and/or relocate the display device 102 without concerns associated with peripherals externally attached on or around the display device 102.

In still another embodiment illustrated in FIG. 12, a posture-correcting system 1200 comprises a plurality of posture-maintaining devices 100, 500 (FIG. 2, FIG. 5A), removably mounted on a plurality of surfaces 902,1204 of the display device 102. Mounting means may include an adhesive member 216 (FIG. 2) or securing means 518 (FIG. 5A). The system 1200 of FIG. 12 is operable to allow a user 104 (FIG. 1) to maintain a longitudinal alignment of the user 104 with respect to the display device 102 using the posture-checking device 100, 500 on a top surface 902 of the display device 102, while maintaining a lateral alignment of the user 104 with respect to the display device 102 using the posture-checking device 100, 500 mounted on at least one side surface 1204 of the display device 102, as shown in FIG. 12.

A user 104 of FIG. 1 may make use of the system 1200 in applications such as, but not limited to, interacting with display devices 102 that are configured to capture an image of the user, where both longitudinal and lateral alignment of the user's body determines the outcome of the image. Additionally, or alternatively, the system 1200 may be used in applications such as, but not limited to, those that involve manipulating or viewing graphics or digital images, where the lateral position of the user with respect to the display device 102 may affect a perspective of the user 104 with respect to the graphics or the image or the colors therein.

It will be understood that various embodiments may be used in applications beyond those discussed in this disclosure of exemplary embodiments. For example, medical and dental applications may use a posture-checking device 100 to provide a patient with a datum to monitor and maintain the patient's posture while a physician or dentist is performing tasks on the patient, or alternatively while a barber is performing tasks on a customer. Additionally, or alternatively, pilots may use the posture-checking device 100 to maintain proper posture and/or maintain proper alignment with respect to an instrument panel during a flight. Additionally, or alternatively, grocery store clerks may use the posture-checking device 100 to maintain proper posture while working for a prolonged period to reduce fatigue and other problems associated with poor posture as discussed herein. Additionally, or alternatively, a posture-checking device 100 may be used proximate to emerging identification devices, such as retinal identification devices, to maintain a user's posture in a proper position for the identification device to effectively operate. An individual of ordinary skill in the art, having reviewed this disclosure, will appreciate these and other applications for which a posture-checking device 100 can be used.

All of the above U.S. patents, U.S. patent application publications, U.S. patent applications, foreign patents, foreign patent applications and non-patent publications referred to in this specification and/or listed in the Application Data Sheet, including but not limited to 60/639,862 filed Dec. 27, 2004 or 60/738,490 filed Nov. 21, 2005, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A posture-checking device for use by a user of a display device in maintaining posture over time, the posture-checking device comprising:
reflecting means for reflecting a reference-datum fixedly associated with the user of the display device, the reflecting means mounted for movement with respect to the display device to setup the posture-checking device for the user; and
at least one datum indicia positioned to provide a reference datum extending at least partially across a portion of the reflecting means to provide an indicia of proper posture when the reflected reference-datum is aligned with respect to the at least one datum indicia.

2. The posture-checking device of claim 1 wherein the reflecting means comprises a reference-datum locating member including a first reflective surface and at least one coupling member for pivotally coupling the reference-datum locating member about a first rotational axis with respect to the display device.

3. The posture-checking device of claim 2 wherein the at least one datum indicia is carried by the reference-datum locating member.

4. The posture-checking device of claim 2 wherein the at least one datum indicia is at least one of inscribed or etched on, in or under the first reflective surface of the reference-datum locating member.

5. The posture-checking device of claim 2 wherein the datum indicia is a line substantially parallel to the first rotational axis of the reference-datum locating member.

6. The posture-checking device of claim 5 wherein the first reflective surface is substantially symmetrical about the datum indicia.

7. The posture-checking device of claim 2 wherein the datum indicia is a region extending substantially parallel to the first rotational axis of the reference-datum locating member.

8. The posture-checking device of claim 2, further comprising:
an illumination device operable to emit an illumination beam to form the datum indicia.

9. The posture-checking device of claim 2 wherein the reference-datum locating member includes at least a second surface, the second surface bearing viewable a message.

10. The posture-checking device of claim 2 wherein the reference-datum locating member includes at least a third surface, the third surface viewable when the reference-datum locating member is pivoted about the first rotational axis so as to obscure the first reflective surface from a view of the user.

11. The posture-checking device of claim 1, further comprising:
a frame comprising a base and at least one support member coupled to the base; and
means for securing the base to the display device.

12. The posture-checking device of claim 11 wherein the securing means comprises a hook and loop fastener including a first fastener layer adjacent the base and a second fastener layer securable to a surface of the display device.

13. The posture-checking device of claim 11 wherein the securing means comprises an adhesive layer, the adhesive layer substantially covered by a removable release liner prior to use.

14. The posture-checking device of claim 1 wherein the reference-datum locating member is pivotally mounted in a receptacle formed in the display device.

15. A posture-checking system for a display device, the posture-checking system comprising:
at least a first reference-datum locating device having a reflective surface and at least a first datum indicia; and
first mounting means for movably mounting the first reference-datum locating device for movement with respect to the display device to selectively align at least the first datum indicia with a reference-datum fixedly associated with a user to provide a first visual indication of when the user is correctly postured.

16. The posture-checking system of claim 15 wherein the first mounting means mounts the first reference-datum locating device for movement about a first axis of rotation.

17. The posture-checking system of claim 16 wherein the first datum indicia extends substantially parallel to the first axis of rotation.

18. The posture-checking system of claim 16 wherein the first axis of rotation is substantially parallel to a horizontal axis of the display device.

19. The posture-checking system of claim 16, further comprising:
at least a second reference-datum locating device having a reflective surface and at least a second datum indicia; and
second mounting means for movably mounting the second reference-datum locating device for movement with respect to the display device to selectively align at least the second datum indicia with a reference-datum fixedly associated with the user to provide a second visual indication of when the user is correctly postured.

20. The posture-checking system of claim 19 wherein the first mounting means mounts the first reference-datum for movement about a second axis of rotation, different from the first axis of rotation.

21. The posture-checking system of claim 19 wherein the first axis of rotation is substantially parallel to a horizontal axis of the display device and wherein the second mounting means mounts the second reference-datum locating device for movement about a second axis of rotation, the second axis of rotation is substantially parallel to a vertical axis of the display device.

22. The posture-checking system of claim 21, further comprising:
at least a third reference-datum locating device having a reflective surface and at least a third datum indicia; and
third mounting means for movably mounting the third reference-datum locating device for movement with respect to the display device to selectively align at least the third datum indicia with a reference-datum fixedly associated with the user to provide a third visual indication of when the user is correctly postured.

23. The posture-checking system of claim 22 wherein the third mounting means mounts the third reference-datum locating device for movement about a third axis of rotation, the third axis of rotation is substantially parallel to the vertical axis of the display device, and spaced from the second axis of rotation.

24. The posture-checking system of claim 22 wherein at least one of the first reference-datum locating device, the second reference-datum locating device, or the third reference-datum locating device is mounted at least partially in a receptacle formed in the display device.

25. The posture-checking system of claim 22 wherein at least one of the first reference-datum locating device, the second reference-datum locating device, or the third reference-datum locating device is mounted on an exterior surface of the display device.

26. The posture-correcting system of claim 15 further comprising:
at least one position indicia for selectively relocating a pre-calibrated position of the reflective surface.

27. The posture-correcting system of claim 15 wherein the first reference-datum locating device has at least one surface in addition to the reflective surface, which may be selectively exposed to the user by movement of the first reference-datum locating device with respect to the display device.

28. The posture-correcting system of claim 15 wherein the first reference-datum locating device bears an advertising message.

29. A method for maintaining a proper posture while interacting with a display device, comprising:
positioning a reference-datum locating device proximate to the display device;
assuming a proper posture and aligning a datum indicia of a reflective surface of the reference-datum locating device with a reference-datum fixedly associated with a user and reflected on the reflective surface;
periodically inspecting the reflective surface for alignment of the datum indicia with the reference-datum; and
resuming the proper posture when misalignment of the datum indicia with the reference-datum is detected by realigning the datum indicia with the reference-datum.
